(19) United States
(12) Patent Application Publication
(10) Pub. No.: US 2019/0014263 A1
(43) Pub. Date: Jan. 10, 2019

(54) PAN-TILT VIDEO CAMERA AND LINKAGE CAMERA HAVING THE PAN-TILT VIDEO CAMERA

(71) Applicant: Beijing Deep Glint Technology Limited, Haidian District, Beijing (CN)

(72) Inventors: Yong ZHAO, Haidian District, Beijing (CN); Feng ZHANG, Haidian District, Beijing (CN); Feng LV, Haidian District, Beijing (CN); Ruhui ZHOU, Haidian District, Beijing (CN); Miao ZHOU, Haidian District, Beijing (CN); Yang CAI, Haidian District, Beijing (CN); Bin HU, Haidian District, Beijing (CN)

(21) Appl. No.: 16/069,498

(22) PCT Filed: Sep. 26, 2016
(86) PCT No.: PCT/CN2016/100122

§ 371 Date: Jul. 11, 2018

(30) Foreign Application Priority Data
Mar. 31, 2016 (CN) 201610196204.6
Mar. 31, 2016 (CN) 201620262659.9

(51) Int. Cl. H04N 5/232; H04N 5/225; G06K 9/00

(52) U.S. Cl. CPC H04N 5/23299; H04N 5/23254; G06K 9/00771; H04N 5/2251

(57) ABSTRACT

Provided are a pan-tilt video camera and a linkage camera having the pan-tilt video camera. The pan-tilt video camera includes a video camera, a pan and tilt head, a pan-tilt holder and a reflector arranged on the pan-tilt holder. An optical axis of the camera is collinear with a center of the reflector; the pan and tilt head is used for receiving moving object information, and driving, according to the moving object information, the reflector to rotate; and the camera is used for shooting a moving object reflected by the reflector. By adopting the solution provided in the present application, the response speed of rotation can be improved, thereby performing fast-tracking and shooting on a fast moving target.

The present application claims the priorities to Chinese Patent Application No. 201620262659.9 titled “PAN-TILT-ZOOM CAMERA AND LINKAGE CAMERA”, filed with the Chinese State Intellectual Property Office on Mar. 31, 2016, and Chinese Patent Application No. 201610196204.6 titled “PAN-TILT-ZOOM CAMERA AND LINKAGE CAMERA”, filed with the Chinese State Intellectual Property Office on Mar. 31, 2016, the entire disclosures of which applications are incorporated herein by reference.

### FIELD

The present application relates to the technical field of video surveillance, and particularly relates to a pan-tilt-zoom camera and a linkage camera having the pan-tilt-zoom camera.

### BACKGROUND

There are usually multiple fast moving objects of interest in a large-scale scene, and if the multiple fast moving objects of interest can be seen, seen clearly and captured in the large-scale scene, sudden emergency events can be handled quickly and effectively. Therefore, a wide-angle gun-type camera is required to be capable of detecting multiple fast moving objects in a surveillance scope, and a long-focus spheroidal pan-tilt-zoom camera is required to be capable of cooperating with a moving object detecting algorithm to perform quick feature tracking and object detail feature information capturing to multiple fast moving objects of interest in the surveillance scope of the wide-angle gun-type camera in sequence.

Generally, a video surveillance camera can hardly see fully and see clearly simultaneously, that is, the detail feature information of the object cannot be captured in a large-scale scene, and other objects around can hardly be taken into account while focusing on the detail feature information of the object. At present, a linkage camera is usually employed to address the above issues, that is, a wide-angle gun-type camera is employed to realize a coverage surveillance of the large-scale scene, and to detect the objects in the scene to see fully, and the object detecting algorithm and the long-focus spheroidal pan-tilt-zoom camera cooperate to track and capture the detail feature information of the objects of interest to see clearly, so that seeing fully and seeing clearly are taken into account simultaneously.

In the long-focus spheroidal pan-tilt-zoom camera of the conventional linkage camera, a long-focus camera is fixedly mounted on a pan-tilt-zoom holder, the long-focus camera and the pan-tilt-zoom holder as a whole perform horizontal rotation and pitching rotation together, and the mass and rotational inertia of the rotating components are very large, therefore the pan and tilt head responds slowly in rotation (starts and stops slowly), making the quick close-up tracking and object detail feature information capturing of fast moving objects difficult. For quick close-up tracking and object detail feature information capturing of fast moving objects, higher driving force and strength requirements are put forward to the driving system and the transmission system of the pan and tilt head, which increases the cost of the pan and tilt head greatly.

The long-focus spheroidal pan-tilt-zoom camera of the conventional linkage camera has a low response speed, and can hardly perform close-up tracking and detail capturing of fast moving objects.

### SUMMARY

A pan-tilt-zoom camera and a linkage camera having the pan-tilt-zoom camera are provided according to the present application, so as to solve the technical problems in the conventional technology that a long-focus spheroidal pan-tilt-zoom camera of a linkage camera has a low response speed and can hardly perform close-up tracking and detail capturing of fast moving objects.

A pan-tilt-zoom camera is provided according to the present application, including: a camera, a pan and tilt head, a pan-tilt-zoom holder and a reflector arranged on the pan-tilt-zoom holder; an optical axis of the camera is collinear with a center of the reflector;

The pan and tilt head is used for receiving moving object information, and driving, according to the moving object information, the reflector to rotate; the camera is used for shooting a moving object reflected by the reflector.

The pan and tilt head can drive the reflector to rotate, according to the moving object information. The camera is only required to shoot the moving object reflected by the reflector, and the camera does not need to rotate. The mass and the rotational inertia of the reflector are much smaller than the mass and the rotational inertia of the camera, therefore, by rotating the conventional camera instead of the reflector, the response speed of the rotation can be greatly increased, so as to quickly track and shoot the fast moving object. Moreover, the driving force and strength requirements of the pan and tilt head are lowered, thus reducing the cost of the pan and tilt head.

A linkage camera, including a wide-angle gun-type camera, a front-end video analysis processor and the pan-tilt-zoom camera is provided according to another embodiment of the present application.

The camera included in the pan-tilt-zoom camera is a long-focus camera;

the wide-angle gun-type camera is used for transmitting a collected surveillance video to the front-end video analysis processor; and

the front-end video analysis processor is used for detecting a moving object in the surveillance video and sending a dispatching instruction to the pan-tilt-zoom camera, and the dispatching instruction includes a moving object information.

The pan and tilt head of the pan-tilt-zoom camera drives the reflector and the pan-tilt-zoom holder to rotate, the long-focus camera is only required to shoot the moving object reflected by the reflector, and does not need to rotate. Since a rotating component is changed from the conventional long-focus camera to the reflector, the mass and the rotational inertia of the rotating component are reduced, and the driving force and strength requirements of a driving system and a transmission system of the pan and tilt head are lowered accordingly, thus increasing the response speed of rotation and simultaneously reducing the cost of the pan and tilt head, so that the long-focus camera can be employed to quickly perform close-up tracking and object detail feature information capturing of the fast moving objects.

### BRIEF DESCRIPTION OF THE DRAWINGS

Specific embodiments of the present application will be described hereinafter with reference to the drawings:

FIG. 1 is a schematic view showing the structure of a pan-tilt-zoom camera according to an embodiment of the present application; and

FIG. 2 is a schematic view showing the structure of a linkage camera according to an embodiment of the present application;

| | | | |
|---|---|---|---|
| 10 | wide-angle gun-type camera, | 20 | pan-tilt-zoom camera, |
| 30 | front-end video analysis processor, | 40 | linkage camera, |
| 201 | camera, | 202 | pan-tilt head, |
| 203 | pan-tilt-zoom holder, | 204 | reflector, |
| 205 | camera holder. | | |

### DETAIL DESCRIPTION

The exemplary embodiments of the present application will be further described in detail hereinafter in conjunction with the accompany drawings, so that the technical solution of the present application can be more obvious and understandable. It is obvious that the described embodiments are only a part of the embodiments according to the present application, rather than the exhaustion of all embodiments, and in the case of no conflict, the embodiments and the features in the embodiments can be combined with each other.

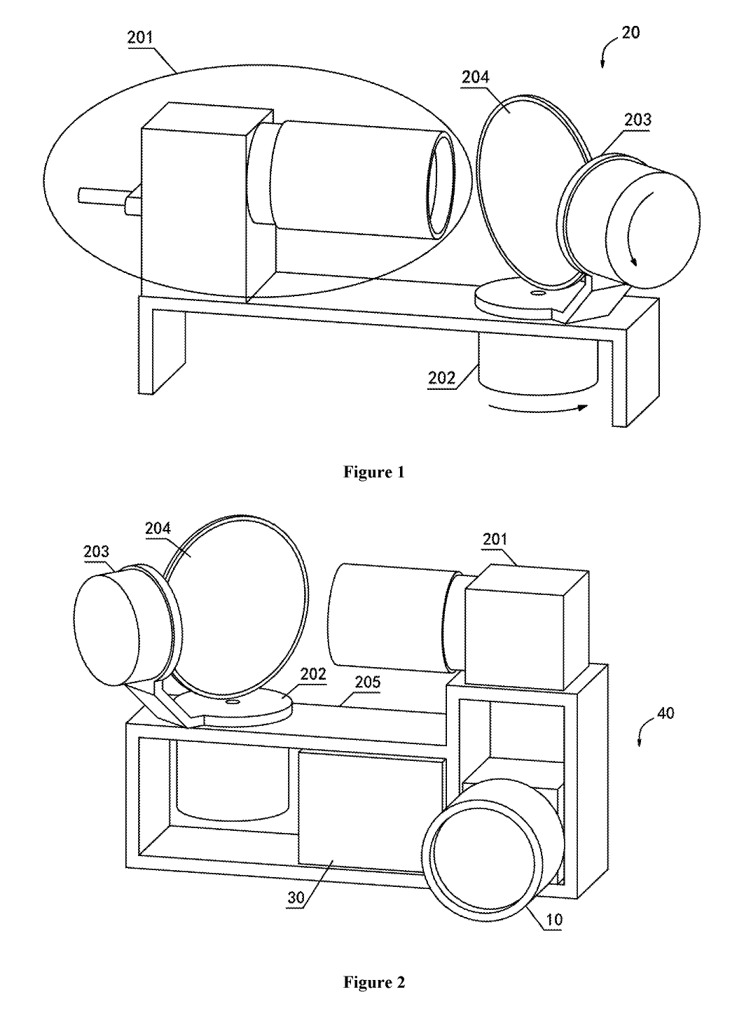

FIG. 1 is a schematic view showing the structure of a pan-tilt-zoom camera according to an embodiment of the present application. As shown in FIG. 1, the pan-tilt-zoom camera 20 includes: a camera 201, a pan and tilt head 202, a pan-tilt-zoom holder 203 and a reflector 204 arranged on the pan-tilt-zoom holder 203, an optical axis of the camera 201 is collinear with a center of the reflector 204.

The pan and tilt head 202 is used for receiving moving object information, and driving, according to the moving object information, the reflector 204 to rotate. The camera 201 is used for shooting a moving object reflected by the reflector 204. The camera 201 includes a camera body, a lens and other accessories such as a rope, a cable and the like. The pan and tilt head 202 can drive the reflector 204 to rotate according to the moving object information, the camera 201 just shoots the moving object reflected by the reflector 204, and the camera 201 does not need to rotate. The mass and the rotational inertia of the reflector 204 are much smaller than the mass and the rotational inertia of the camera 201 (for example, the mass of the camera is usually 150 g, while the mass of the reflector is usually only 10 g). Therefore, by rotating the reflector 204 instead of the conventional camera 201, the response speed of rotation can be greatly increased, thus the fast moving object can be quickly tracked and shot, and moreover, the driving force and strength requirements of the pan and tilt head 202 are lowered, thereby reducing the cost of the pan and tilt head 202.

In addition, since the camera 201 is not required to rotate in the embodiments of the present application, dragging of the camera cable is avoided, so that wastage of the camera cable during the shooting process can be reduced, and the service life of the camera 201 can be prolonged.

The pan and tilt head 202 and the pan-tilt-zoom holder 203 are fixedly connected, and an intersection point of a horizontal rotation axis and a pitching rotation axis of the pan and tilt head 202 is collinear with the center of the reflector 204.

The pan and tilt head 202, the pan-tilt-zoom holder 203 and the reflector 204 are of an integral structure, and when rotating according to the moving object information, the pan and tilt head 202 and the reflector 204 rotates simultaneously.

The pan and tilt head 202 is located right under the reflector 204, and the intersection point of the horizontal rotation axis and the pitching rotation axis of the pan and tilt head 202 is collinear with the center of the reflector 204.

The pan-tilt-zoom camera 20 further includes a camera holder 205. The pan and tilt head 202, the pan-tilt-zoom holder 203 and the camera 201 are arranged on the camera holder 205. The pan-tilt-zoom holder 203 is placed on one end of the camera holder 205, while the camera 201 is placed on the other end of the camera holder 205. The camera holder 205 has a predetermined length.

Since a size of the reflector 204 may be different with a size of the camera 201, the two ends of the camera holder 205 can be of different heights, so as to make the optical axis of the camera 201 collinear with the center of the reflector 204.

The camera holder 205 includes a first vertical structure, a first horizontal structure and a second vertical structure, and two ends of the first horizontal structure are fixedly connected to the first vertical structure and the second vertical structure respectively, so that the horizontal structure has a predetermined height from a horizontal plane. The pan-tilt-zoom holder 203, the pan and tilt head 202, the reflector 204 and the camera 201 are all placed on the horizontal structure.

A hole is provided in an end of the first horizontal structure, at which end the pan and tilt head 202, the pan-tilt-zoom holder 203, and the reflector 204 are placed. The pan and tilt head 202 is placed in the hole, and a periphery of the pan and tilt head 202 is fitted to or has a predetermined distance from the hole.

The pan and tilt head 202 is of a cylindrical shape, and the hole is a circular hole. It should be known to those skilled in the field that, the pan and tilt head 202 can be made into other shapes, for example: cube, rectangular solid and the like. The hole can be of a square shape, a rectangular shape or the like, which is not limited in the present application, as long as the shape of the hole is the same as the shape of a cross section of the pan and tilt head 202, or the hole is larger than the cross section of the pan and tilt head 202 in shape.

The camera holder 205 further includes a second horizontal structure. The second horizontal structure is located under the first horizontal structure and is parallel with the first horizontal structure, and is spaced apart from the first horizontal structure with a predetermined distance. Two ends of the second horizontal structure are fixedly connected to the first vertical structure and the second vertical structure respectively. In practical usage, the second horizontal structure is placed on the ground or other planes, so as to further improve the stability of the camera holder 205.

The reflector 204 may be a planar reflector, a concave reflector or a convex reflector and the like, the planar reflector directly reflects the actual moving object, the concave reflector or the convex reflector may distort or change the actual moving object to a certain extent. In specific usage, the actual moving object can be restored through a certain design and calculation by those skilled in the field, the specific design and calculation methods can employ the conventional technology, which will not be described in details in the present application.

The reflector 204 is of a round shape, a rectangular shape or the like, which is not limited in the present application.

Based on the same concept, a linkage camera is further provided according to an embodiment of the present application, which will be illustrated hereinafter.

FIG. 2 is a schematic view showing the structure of the linkage camera according to the embodiment of the present application. As shown in the drawing, the linkage camera includes: a wide-angle gun-type camera 10, a front-end video analysis processor 30 and the above pan-tilt-zoom camera 20.

The camera 201 included in the pan-tilt-zoom camera 20 is a long-focus camera, the wide-angle gun-type camera 10 is used for transmitting a collected surveillance video to the front-end video analysis processor 30, and the front-end video analysis processor 30 is used for detecting the moving object in the surveillance video and sending a dispatching instruction to the pan-tilt-zoom camera 20. The dispatching instruction includes the moving object information.

The wide-angle gun-type camera can transmit the video information to the front-end video analysis processor, the front-end video analysis processor can detect the multiple fast moving objects in the surveillance scope by employing the predetermined object detecting algorithm, and dispatch the pan-tilt-zoom camera to quickly perform close-up tracking and object detail feature information capturing for multiple interested fast moving objects in the surveillance scope of the wide-angle gun-type camera in sequence.

The wide-angle gun-type camera employs the conventional wide-angle gun-type camera, as long as the functions of surveillance video collection and transmission are provided. The moving objects detecting and dispatching instruction sending and the like performed by the front-end video analysis processor can all realized by employing the conventional technology, which will not be described in the present application.

The pan and tilt head of the pan-tilt-zoom camera drives the reflector and the pan-tilt-zoom holder to rotate, the long-focus camera is only required to shoot the moving object reflected by the reflector and does not need to rotate. Since a rotating component is changed from the conventional long-focus camera to the reflector, the mass and the rotational inertia of the rotating component decrease, and the driving force and strength requirements on a driving system and a transmission system of the pan-tilt-zoom are lowered accordingly, which increases the response speed of rotation and also reduces the cost of the pan and tilt head, so that the long-focus camera can be employed to quickly perform close-up tracking and object detail feature information capturing of the fast moving objects, that is, multiple fast moving objects of interest can be seen, seen clearly and captured in the large-scale scene, so that the sudden emergency events can be handled quickly and effectively.

The principle and the embodiments of the present application are illustrated herein by specific examples. The above description of the embodiments is only intended to help the understanding of the solution of the present application. The protection scope of the present application should be defined by the claims.

1. A pan-tilt-zoom camera, comprising a camera, a pan and tilt head, a pan-tilt-zoom holder, and a reflector arranged on the pan-tilt-zoom holder, wherein:
an optical axis of the camera is collinear with a center of the reflector;
the pan and tilt head is used for receiving moving object information, and driving, according to the moving object information, the reflector to rotate; and
the camera is used for shooting a moving object reflected by the reflector.

2. The pan-tilt-zoom camera according to claim 1, wherein the pan and tilt head and the pan-tilt-zoom holder are fixedly connected, an intersection point of a horizontal rotation axis and a pitching rotation axis of the pan and tilt head is collinear with the center of the reflector.

3. The pan-tilt-zoom camera according to claim 1, wherein the pan-tilt-zoom camera further comprises a camera holder;
the pan-tilt-zoom holder is located at an end of the camera holder, and the camera is located at another end of the camera holder.

4. The pan-tilt-zoom camera according to claim 3, wherein the camera holder comprises a first vertical structure, a first horizontal structure and a second vertical structure, and two ends of the first horizontal structure are fixedly connected to the first vertical structure and the second vertical structure respectively.

5. The pan-tilt-zoom camera according to claim 4, wherein an end of the first horizontal structure is provided with a hole, and the pan and tilt head is located in the hole and connected to the first horizontal structure.

6. The pan-tilt-zoom camera according to claim 5, wherein the pan and tilt head is of a cylindrical shape, and the hole is a circular hole.

7. The pan-tilt-zoom camera according to claim 4, wherein the camera holder further comprises a second horizontal structure;
the second horizontal structure is parallel with the first horizontal structure and spaced apart from the first horizontal structure at a predetermined distance, and two ends of the second horizontal structure are fixedly connected to the first vertical structure and the second vertical structure respectively.

8. The pan-tilt-zoom camera according to claim 1, wherein the reflector may be a planar reflector, a concave reflector or a convex reflector.

9. The pan-tilt-zoom camera according to claim 1, wherein the reflector is of a round shape.

10. A linkage camera, comprising a wide-angle gun-type camera, a front-end video analysis processor and the pan-tilt-zoom camera according to claim 1, wherein:
the pan-tilt-zoom camera is a long-focus camera;
the wide-angle gun-type camera is used for transmitting a collected surveillance video to the front-end video analysis processor; and
the front-end video analysis processor is used for detecting a moving object in the surveillance video and sending a dispatching instruction to the pan-tilt-zoom camera, and the dispatching instruction comprises the moving object information.

11. A linkage camera, comprising a wide-angle gun-type camera, a front-end video analysis processor and the pan-tilt-zoom camera according to claim 2, wherein:
the pan-tilt-zoom camera is a long-focus camera;
the wide-angle gun-type camera is used for transmitting a collected surveillance video to the front-end video analysis processor; and
the front-end video analysis processor is used for detecting a moving object in the surveillance video and sending a dispatching instruction to the pan-tilt-zoom camera, and the dispatching instruction comprises the moving object information.

12. A linkage camera, comprising a wide-angle gun-type camera, a front-end video analysis processor and the pan-tilt-zoom camera according to claim 3, wherein:
the pan-tilt-zoom camera is a long-focus camera;
the wide-angle gun-type camera is used for transmitting a collected surveillance video to the front-end video analysis processor; and
the front-end video analysis processor is used for detecting a moving object in the surveillance video and sending a dispatching instruction to the pan-tilt-zoom camera, and the dispatching instruction comprises the moving object information.

13. A linkage camera, comprising a wide-angle gun-type camera, a front-end video analysis processor and the pan-tilt-zoom camera according to claim 4, wherein:
the pan-tilt-zoom camera is a long-focus camera;
the wide-angle gun-type camera is used for transmitting a collected surveillance video to the front-end video analysis processor; and
the front-end video analysis processor is used for detecting a moving object in the surveillance video and sending a dispatching instruction to the pan-tilt-zoom camera, and the dispatching instruction comprises the moving object information.

14. A linkage camera, comprising a wide-angle gun-type camera, a front-end video analysis processor and the pan-tilt-zoom camera according to claim 5, wherein:
the pan-tilt-zoom camera is a long-focus camera;
the wide-angle gun-type camera is used for transmitting a collected surveillance video to the front-end video analysis processor; and
the front-end video analysis processor is used for detecting a moving object in the surveillance video and sending a dispatching instruction to the pan-tilt-zoom camera, and the dispatching instruction comprises the moving object information.

15. A linkage camera, comprising a wide-angle gun-type camera, a front-end video analysis processor and the pan-tilt-zoom camera according to claim 6, wherein:
the pan-tilt-zoom camera is a long-focus camera;
the wide-angle gun-type camera is used for transmitting a collected surveillance video to the front-end video analysis processor; and
the front-end video analysis processor is used for detecting a moving object in the surveillance video and sending a dispatching instruction to the pan-tilt-zoom camera, and the dispatching instruction comprises the moving object information.

16. A linkage camera, comprising a wide-angle gun-type camera, a front-end video analysis processor and the pan-tilt-zoom camera according to claim 7, wherein:
the pan-tilt-zoom camera is a long-focus camera;
the wide-angle gun-type camera is used for transmitting a collected surveillance video to the front-end video analysis processor; and
the front-end video analysis processor is used for detecting a moving object in the surveillance video and sending a dispatching instruction to the pan-tilt-zoom camera, and the dispatching instruction comprises the moving object information.

17. A linkage camera, comprising a wide-angle gun-type camera, a front-end video analysis processor and the pan-tilt-zoom camera according to claim 8, wherein:
the pan-tilt-zoom camera is a long-focus camera;
the wide-angle gun-type camera is used for transmitting a collected surveillance video to the front-end video analysis processor; and
the front-end video analysis processor is used for detecting a moving object in the surveillance video and sending a dispatching instruction to the pan-tilt-zoom camera, and the dispatching instruction comprises the moving object information.

18. A linkage camera, comprising a wide-angle gun-type camera, a front-end video analysis processor and the pan-tilt-zoom camera according to claim 9, wherein:
the pan-tilt-zoom camera is a long-focus camera;
the wide-angle gun-type camera is used for transmitting a collected surveillance video to the front-end video analysis processor; and
the front-end video analysis processor is used for detecting a moving object in the surveillance video and sending a dispatching instruction to the pan-tilt-zoom camera, and the dispatching instruction comprises the moving object information.
